(19) United States
(12) Patent Application Publication
(10) Pub. No.: US 2008/0149873 A1
(43) Pub. Date: Jun. 26, 2008

(54) Valve with push-fit connection

(75) Inventors: Roberto Cimberio, San Maurizio d'Opaglio (IT); James P. McHugh, Berwyn, PA (US)

Correspondence Address: BUCHANAN, INGERSOLL & ROONEY PC, POST OFFICE BOX 1404, ALEXANDRIA, VA, 22313-1404, US

(73) Assignee: Cimberio Valve Co., Inc., Malvern, PA (US)

(21) Appl. No.: 11/641,672

(22) Filed: Dec. 20, 2006

(51) Int. Cl. F16L 37/28

(52) U.S. Cl. 251/149.6

(57) ABSTRACT

A valve includes a housing with at least one inlet and at least one outlet with a valve member provided within the housing. The valve member is selectively positioned to control communication between the at least one inlet and the at least one outlet with the valve housing having a teeth ring with a plurality of teeth directed generally radially inwardly and generally toward the interior of the valve housing. In a preferred embodiment, an annular sealing member is provided between the teeth ring and the valve member with a first shoulder limiting movement of the teeth ring toward the valve member. An annular ring is provided between the teeth ring and the first shoulder and a second shoulder is provided between the first shoulder and the valve member. A third shoulder is provided between the second shoulder and the valve member with the third shoulder having a diameter corresponding to the outside diameter of a pipe to be received within the teeth ring.

### FIELD OF THE INVENTION

The present invention relates to valves and valve connections for joining inlets and outlets of valves to piping and to other fittings.

### BACKGROUND OF THE INVENTION

Valves typically have one or more inlets which admit fluid such as water to an interior of the valve. Valves also typically have one or more outlets through which fluid from the interior of the valve may exit the valve. A valve member which is provided within the interior of the valve selectively connects one or more of the inlets with one or more of the outlets to open the valve. The valve member also selectively prevents communication between one or more of the inlets and one or more of the outlets to close the valve.

In the prior art, the inlets and outlets of valves are typically threaded so as to receive a corresponding threaded end of a section of pipe or another pipe fitting. Frequently, pipe joint compound, Teflon tape or another sealing substance is first provided on the threads of the valve, the pipe or fitting or both in order to facilitate a leak-proof connection between the valve and the pipe or fitting. The pipe or fitting is then rotated to engage the threads of the pipe or fitting with the threads of the valve inlet or outlet. In the case of a threaded coupling, it is important not to under-tighten or to over-tighten the connection. If the threads are under-tightened, the connection will not be structurally sound and may also likely leak. If the threads are over-tightened, the threads may be damaged with the resulting inability to properly connect the valve inlet or outlet with the pipe or other fitting.

The application of the sealing substance to the threads, the amount of time needed to rotate the pipe or fitting to engage the threads, as well as the difficulty in properly tightening the threads makes the use of a threaded coupling undesirable in many situations. In addition, sometimes it is physically impossible to rotate the pipe or fitting with respect to the valve, perhaps because both the valve and the pipe or fitting are already joined to another component which cannot rotate or because there is inadequate space to permit the valve or other fitting to rotate.

Accordingly, the need remains for an arrangement for connecting a valve to piping or other fittings which overcomes the difficulties in the prior art.

Various arrangements for connecting non-threaded pipe ends and pipe fittings are known in the art, such as are shown in U.S. Pat. No. 5,409,066 of McHugh and U.S. Pat. No. 5,609,212 of McHugh. Similarly, various embodiments of push-fit connectors have long been known for joining pipe ends and tubing ends together, such as are shown in, for example, U.S. Pat. No. 3,312,484 of Davenport, U.S. Pat. No. 3,365,219 of Nicolaus, U.S. Pat. No. 3,924,882 of Ellis, U.S. Pat. No. 5,188,401 of Staniforth, U.S. Pat. No. 5,593,186 of Harris, U.S. Patent Application Publication No. 2004/0090067 of Pridham, U.S. Patent Application Publication No. 2005/0084327 of Chelchowski et al., U.S. Patent Aplication Publication No. 2005/0104369 of Webb et al., UK Patent Application Publication No. GB 2 280 006 of THD Manufacturing Limited, and UK Patent Application Publication No. GB 2 266 569 of F W Talbot & Company Limited. These patent publications are primarily concerned with connecting pipe ends together in a push-fit or quick connect arrangement.

Other push-fit connections for pipe ends are available from Cash Acme at the website: http://www.cashacme.com/sharkbite.html, under the trademark SharkBite Connection System. The SharkBite connections spin around the pipe and are removable with a specially designed tool which releases a teeth ring. Other push-fit connections which spin around the pipe are available from I-TAP under the trademark Itap-Fit at the website: http://www.itap.it. N-Vent sells push-fit connectors for pipe ends and valves with push-fit connectors which make a permanent, unmovable & non removable connection under the trademark PermaLynx at the website http://www.nventsolutions.com.

### SUMMARY OF THE INVENTION

In various preferred embodiments of the present invention, a valve comprises a valve housing which in turn comprises an inlet and an outlet. A valve member is provided within the valve housing with the valve member being selectively positioned to control communication between the inlet and the outlet. The valve housing further comprises an integrally formed push-fit connection arrangement comprising a teeth ring having a plurality of teeth directed generally radially inwardly and generally toward the interior of the valve housing. The teeth ring is provided within at least one of the inlet and the outlet of the valve housing.

Preferably, the valve further comprises an annular sealing member which is provided between the teeth ring and the valve member. The valve housing further comprises a first shoulder which limits movement of the teeth ring toward the valve member. An annular ring is provided between the teeth ring and the first shoulder. If desired, the teeth ring and the annular ring may be integrally formed.

In a preferred embodiment, the valve housing further comprises a second shoulder which is provided between the first shoulder and the valve member. The second shoulder has a smaller diameter than the first shoulder. The annular sealing member is provided between the second shoulder and the annular ring. The valve housing further comprises a third shoulder provided between the second shoulder and the valve member. The third shoulder has a smaller diameter than the second shoulder.

Preferably, the third shoulder has a diameter corresponding to the outside diameter of a pipe to be received within the teeth ring. The sealing member, when not compressed, has an inside diameter which is smaller than the outside diameter of the pipe to be received within the teeth ring. The sealing member is preferably an O-ring, with the second shoulder and the annular ring forming a groove for the O-ring.

In a preferred embodiment, the valve further comprises a teeth ring retainer which maintains the teeth ring positioned between the first shoulder and the teeth ring retainer. The teeth ring retainer is permanently fixed to the valve housing and the valve member is a ball.

In a preferred embodiment, each of the at least one inlet and the at least one outlet of the valve housing comprises a teeth ring having a plurality of teeth directed in a generally radial direction, inwardly and generally toward the interior of the valve housing with an annular sealing member provided between the teeth ring and the valve member. A first shoulder limits movement of the teeth ring toward the valve member and an annular ring is provided between the teeth ring and the first shoulder. A second shoulder is provided between the first shoulder and the valve member with the second shoulder having a smaller diameter than the first shoulder. The annular sealing member is provided between the second shoulder and the annular ring. A third shoulder is provided between the second shoulder and the valve member with the third shoulder having a smaller diameter than the second shoulder. The third shoulder has a diameter corresponding to the outside diameter of a pipe to be received within the teeth ring. The sealing member, when not compressed, has an inside diameter which is smaller than the outside diameter of the pipe to be received within the teeth ring.

Preferably, the teeth ring retainer maintains the teeth ring positioned between the first shoulder and the teeth ring retainer and each of the teeth ring retainers is permanently fixed to the valve housing. Preferably, the valve member is a ball and the teeth retainer prevents teeth of the teeth ring from moving away from the valve member. The teeth ring retainer has an inner, annular protrusion which prevents teeth of the teeth ring from moving away from the valve member.

In a preferred embodiment, the valve housing comprises a central valve housing member and at least one valve member retainer. Preferably, the valve housing comprises a central valve housing member and first and second valve member retainers, with each of the valve member retainers comprising a teeth ring having a plurality of teeth directed inwardly in a generally radial direction and generally toward the interior of said valve housing.

Preferably, each of the teeth ring retainers is permanently fixed to the respective valve member retainer.

### BRIEF DESCRIPTION OF THE DRAWING FIGURES

The present invention will appear more clearly from the following detailed description of several embodiments illustrated in the enclosed figures in which:

FIG. 1 is a side view in cross section of a valve according to the present invention along the lines B-B of the valve of FIG. 2;

FIG. 2 is an end view of the valve of FIG. 1;

FIG. 3 is an expanded, perspective view of the valve of FIG. 1;

FIG. 4 is a side view of the valve of FIG. 1 with pipe ends inserted into the inlet and outlet of the valve;

FIG. 5 is an expanded view of another valve according to the present invention;

FIG. 6 is a side view in cross section of the valve of FIG. 5;

FIG. 7 is an expanded view of another valve according to the present invention;

FIG. 8 is a side view in cross section of the valve of FIG. 7;

FIG. 9 is a top view of a teeth ring according to the present invention;

FIG. 10 is a perspective view of the teeth ring of FIG. 9;

FIG. 11 is an enlarged view of a portion of the teeth ring of FIG. 10; and,

FIG. 12 is an expanded view of another valve according to the present invention with the teeth ring of FIGS. 9-11.

### DETAILED DESCRIPTION OF THE INVENTION

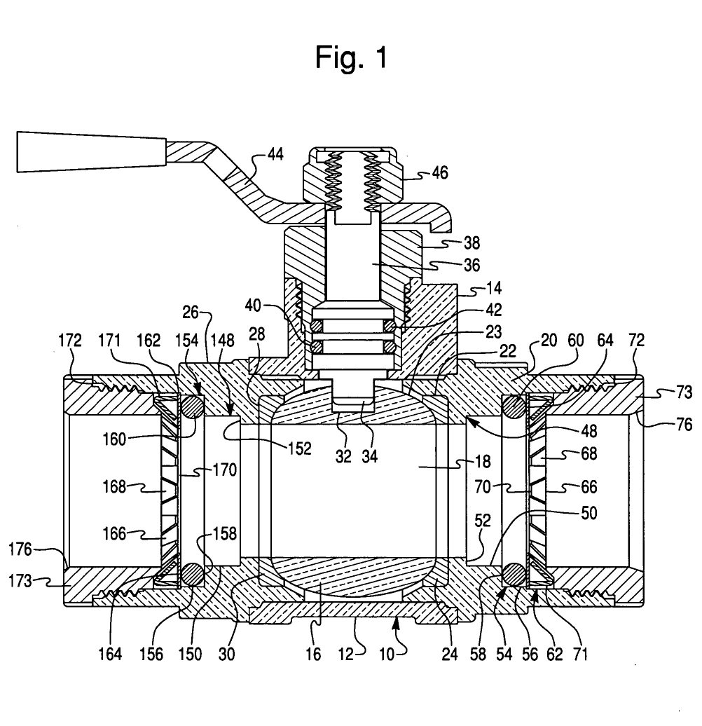

With reference to FIG. 1, a valve 10 comprises a central housing member 12, which is generally cylindrical in shape, having a radially extending portion 14. A ball valve member 16 is provided within the interior of the central housing member 12 and the ball valve member 16 has a passageway 18 which extends through the ball valve member 16. A first ball valve retaining member 20 is threaded into one end of the central housing member. The first ball valve member 20 has a shoulder 22 which carries an annular seal or valve seat 24. The annular seal or valve seat 24 receives an outer surface 23 of the ball valve member 16.

A second ball valve retaining member 26 is threaded into another end of the central housing member 12. The second ball valve member 26 has a shoulder 28 which carries an annular seal or valve seat 30. The annular seal or valve seat 30 receives an outer surface of the ball valve member 16.

Although in the embodiment of FIG. 1, a ball valve is shown, the valve 10 according to the present invention could be a plug valve or cylindrical valve or any other type of valve for use with piping or tubing. Similarly, although the valve of FIG. 1 has only an inlet and an outlet, the valve according to the present invention could have more than one inlet and more than one outlet with some or all of the inlets and outlets having the push-fit connection according to the present invention. In addition, the valve 10 of the present invention has two ball valve retaining members which are threaded into the central valve housing but preferably one (or even both) of the ball valve retaining members could be integrally formed with the central valve housing. If both of the ball valve retaining members are integrally formed with the central valve housing, then another removable member would be provided in order to enable the ball valve member 16 to be inserted into the interior of the valve.

In the preferred embodiment of FIG. 1, the ball valve member 16 has a slot 32 provided at an upper portion of the ball valve member which receives a lowermost portion 34 of a valve stem 36. The valve stem 36 is received within the radial portion 14 of the central valve housing 12. A valve stem retainer 38 is threaded into the radial portion 14 of the central valve housing 12 and maintains the valve stem in engagement with the slot 32 of the ball valve member 16. A pair of O-rings 40, 42 are provided within recesses around the valve stem to prevent leakage between the valve stem 36 and the valve stem retainer 38.

A valve actuator 44 is mounted on the valve stem 36 and retained thereon by a threaded nut 46. The handle or valve actuator 44 is fixed relative to the valve stem 36 so that rotation of the handle 44 rotates the valve stem 36 which in turn rotates the ball valve member 16. In this way, the handle 44 may be used to align the passageway 18 of the ball valve member 16 with the inlet and outlet of the ball valve housing in order to open the valve. The handle may also be used to align solid portions of the ball valve member with one or both of the inlet and outlet of the valve housing in order to close the valve.

The first ball valve retainer 20 has a pipe shoulder 48 which has a diameter along an axial surface 50 which corresponds to and is slightly larger than the outside diameter of the pipe or tubing to be connected to the valve at the first ball valve retainer 20. The shoulder 48 also has an annular, radial surface 52 which limits the axial movement of the pipe or tubing when being urged toward the ball valve member 16.

Moving away from the ball valve member, immediately after the pipe shoulder 48, the first ball valve retainer 20 has an O-ring shoulder 54. The O-ring shoulder 54 has a diameter along an axial surface 56 which is slightly less than the cross-sectional diameter of the O-ring 60 so that the O-ring will be compressed when the pipe or fitting is received within the first ball valve retainer 20. The O-ring shoulder 54 also has an annular, radial surface 58 which has a width which is slightly less than the diameter of the O-ring 60 again so that the O-ring 60 is compressed when the ball valve retainer 20 receives the pipe or fitting. In the preferred embodiment, the sealing member is an O-ring but other suitable sealing members could be used in place of the O-ring 60. For example, an annular lip seal, or gasket, not shown, could be provided on the O-ring shoulder 54 to seal the pipe relative to the ball valve retaining member 20.

Continuing to move away from the ball valve member 16, the ball valve retainer 20 next has an annular ring shoulder 62 which has a diameter that is slightly larger than the O-ring shoulder diameter. An annular ring 64 is positioned on the shoulder with the annular ring 64 having an outside diameter which is slightly less than the outside diameter of the annular ring shoulder 62.

A teeth ring 66 is positioned on the annular ring 64 with a plurality of individual teeth 68 pointed generally inwardly toward the ball valve member 16. The teeth 68 have a generally flat end 70 so as to securely grip the outer surface of the pipe or fitting received within the first ball valve retainer without piercing or damaging the outer pipe surface. The teeth ring is preferably formed of spring steel but other materials may be used for the teeth ring depending upon the composition of the pipe or other fitting to be received by the teeth ring.

The teeth ring 66 has an outer ring portion 71 which extends axially with respect to the ball valve member 16. An annular end surface of the outer ring portion 71 abuts the annular ring 64 so that movement of the teeth ring 66 toward the ball valve member is stopped by the annular ring 64. The teeth ring is bent radially inwardly and toward the ball valve member 16 and is cut away in a series of generally V shaped segments so as to form the individual teeth 68.

A teeth ring retainer 73 is threaded into the first ball valve retainer 20 to maintain the teeth ring 66 in position on the annular ring 64 and to maintain the annular ring 64 in position on the annular ring shoulder.

The teeth ring retainer 73 has an inner diameter which is slightly larger than the outside diameter of the pipe or fitting to be received by the first ball member retainer 20. The teeth ring retainer 73 has a shoulder 72 which abuts the outermost portion of the first ball retainer 20 and thereby limits the position of the teeth ring retainer 73 relative to the teeth ring 66. In this way, the teeth ring retainer is prevented from deforming the teeth ring during assembly of the valve. In addition, the portion of the teeth ring retainer that abuts the teeth ring 66 has a corresponding cross section so as to direct the teeth radially inwardly and generally toward the ball valve member. The axially innermost portion of the teeth ring retainer also prevents the teeth from bending away from the ball valve member, i.e., if the pipe or fitting is being pulled out of the ball valve retainer 20.

During manufacture, a sealant is used on the threads of the ball valve retainer and/or the teeth ring retainer so that the teeth ring retainer is permanently connected to the ball valve retainer. The sealant may be a pipe adhesive suitable for use with the materials used for the ball valve retainer and the teeth ring retainer. In the preferred embodiment, the valve is formed of metal and is intended to receive copper piping although other materials may be used for the valve and for the piping or other fittings to be connected to the valve. For example, the piping received by the at least one inlet and outlet of the valve are preferably copper, but may also be CTS, PVC or CPVC. The valves according to the present invention may also be used with pipe or tubing of polybutylene or PeX (cross-linked polyethylene) but the use of PeX tubing may require the use of an adapter which is provided within the PeX tubing to stiffen the end of the PeX tubing received by the inlet or the outlet. The adapter (not shown) comprises an annular ring which has an outside diameter corresponding to the inside diameter of the uncompressed PeX tubing. The adapter prevents the PeX tubing from being unduly compressed by the teeth ring of the press-fit connection arrangement.

The end of the teeth ring retainer which is positioned axially away from the ball valve member 16 preferably has a tapered end 76 so as to facilitate insertion of the pipe end or fitting into the teeth ring retainer. In this way, the tapered end 76 acts as a guide to direct the pipe end or fitting into the teeth ring retainer.

The second ball valve retainer 26 has a push-fit connection arrangement which is identical to the push-fit connection arrangement for the first ball valve member. Accordingly, the second ball valve retainer has a pipe shoulder 148 which has a diameter along an axial surface 150 which is slightly larger than the outside diameter of the pipe or tubing to be connected to the valve at the second ball valve retainer 26. Although in the preferred embodiment, the first ball valve retainer is configured to receive a pipe or fitting having the same outside diameter as the second ball valve retainer, the valve may be configured to receive different sized pipe in the inlet and in the outlet as will be readily apparent to one skilled in the art. As in the first ball valve retainer, the shoulder 148 also has an annular, radial surface 152 which limits the axial movement of the pipe or tubing when being urged toward the ball valve member 16.

Moving away from the ball valve member, immediately after the pipe shoulder 148, the second ball valve retainer 26 has an O-ring shoulder 154. The O-ring shoulder 154 has a diameter along an axial surface 156 which is slightly less than the cross-sectional diameter of the O-ring 160 so that the O-ring will be compressed when the pipe or fitting is received within the first ball valve retainer 26. The O-ring shoulder 154 also has an annular, radial surface 158 which has a width which is slightly less than the diameter of the O-ring 160 again so that the O-ring 160 is compressed when the ball valve retainer 26 receives the pipe or fitting.

Continuing to move away from the ball valve member 16, the ball valve retainer 26 next has an annular ring shoulder 162 which has a diameter that is slightly larger than the O-ring shoulder diameter. An annular ring 164 is positioned on the shoulder with the annular ring 164 having a outside diameter which is slightly less than the outside diameter of the annular ring shoulder 162.

A teeth ring 166 is positioned on the annular ring 164 with a plurality of teeth 168 pointed generally inwardly towards the ball valve member 16. The teeth 168 have a generally flat end 170 so as to securely grip the outer surface of the pipe or fitting received within the first ball valve retainer without piercing or damaging the outer pipe surface.

The teeth ring 166 has an outer ring portion 171 which extends axially with respect to the ball valve member 16. An annular end surface of the outer ring portion abuts the annular ring 164 and movement of the teeth ring 166 toward the ball valve member is stopped by the annular ring 164. The teeth ring 166 is bent radially inwardly and toward the ball valve member 16 and the teeth ring is cut away in a series of generally V shaped segments so as to form the individual teeth 168.

A teeth ring retainer 173 is threaded into the second ball valve retainer 26 to maintain the teeth ring 166 in position on the annular ring 164 and to maintain the annular ring 164 in position on the annular ring shoulder.

The teeth ring retainer 173 has an inner diameter which is slightly larger than the outside diameter of the pipe or fitting to be received by the second ball member retainer 26. The teeth ring retainer 173 has a shoulder 172 which abuts the outermost portion of the second ball retainer 26 and thereby limits the position of the teeth ring retainer 173 relative to the teeth ring 166. In this way, the teeth ring retainer is prevented from deforming the teeth ring during assembly of the valve. In addition, the portion of the teeth ring retainer that abuts the teeth ring 166 has a corresponding cross section so as to direct the teeth radially inwardly and generally toward the ball valve member. The axially innermost portion of the teeth ring retainer also prevents the teeth from bending away from the ball valve member, i.e., if the pipe or fitting is being pulled out of the second ball valve retainer 26.

As with the first ball valve retainer, during manufacture, a sealant is used on the threads of the second ball valve retainer 26 and/or the teeth ring retainer so that the teeth ring retainer is permanently connected to the ball valve retainer.

The end of the teeth ring retainer positioned axially away from the second ball valve member 26 preferably has a tapered end 176 so as to facilitate insertion of the pipe end or fitting into the teeth ring retainer.

During use, the end of a pipe or tubing that is intended to be received by the first or second ball valve retainer 20, 26 is prepared by cutting the pipe or tubing to the appropriate length (if necessary) preferably with a rotary pipe cutter rather than with a hacksaw or other saw and then removing any burrs or rough material from the end of the pipe or tubing. Preferably, the end of the pipe or tubing is cut squarely so as not to provide an angled end for the pipe or tubing. In this way the end of the pipe or tubing will be squarely seated on the corresponding pipe shoulder 48, 148. After preparation, the end of the pipe or tubing is urged into the teeth ring retainer. The pipe or tubing will encounter resistance to further axial movement when the end of the pipe or tubing encounters the teeth of the teeth ring. However, the teeth provided about the inner circumference of the teeth ring are resilient and may be readily bent by the pipe or tubing as the pipe or tubing is urged into the ball valve retainer.

As the end of the pipe or tubing continues past the ends of the teeth, the pipe or tubing compresses the O-ring into the space bounded by the O-ring shoulder and the annular ring (and by the pipe or tubing). In this way a sealing arrangement is provided by the O-ring between the outer surface of the pipe or tubing and the ball valve retainer. The pipe or tubing is urged toward the ball valve member until the end of the pipe or tubing securely abuts the pipe shoulder. At this time, further movement of the pipe or shoulder toward the ball valve is prevented by the shoulder and movement of the pipe or tubing away from the ball valve is prevented by the engagement of the teeth with the outer surface of the pipe of tubing.

Although it may be possible to insert pipe or tubing simultaneously into both the inlet and the outlet of the valve (or into all of the inlets and outlets of the valve), it is generally preferable to insert pipe or tubing into only one inlet or outlet at a time. After that push-fit connection has been competed, a pipe or tubing may then be inserted into another inlet or outlet of the valve until the connection of the valve to the other piping or fittings is complete.

In the preferred embodiment, the push-fit connections are intended to be used with copper pipe or tubing and are not intended to be disassembled. Instead the valve connections are intended to be used only once.

However, if the teeth ring retainer is not permanently joined to the ball valve member retainer, it may be possible to unscrew the teeth ring retainer from the ball valve retainer and to then pull the pipe (and teeth ring) out of the ball valve retainer. If desired, a new teeth ring may be positioned on the annular ring and the teeth ring retainer again screwed into the ball valve retainer. A pipe or tubing may then be suitably prepared and urged into the teeth ring retainer to make a new push-fit connection for the valve.

In the preferred embodiments of a valve with a push-fit connection arrangement, the teeth ring is snugly held between the teeth ring retainer and the valve housing (or the ball valve retainer) so that the ability of the teeth ring to rotate is significantly reduced or eliminated. In the preferred embodiments, the torgue required to rotate the teeth ring relative to the valve housing (or relative to the ball valve retainer) is at least greater than the torque provided by the valve to rotate (due to gravity) about the pipes or tubings connected to the valve inlet and outlet. When a push-fit connection is used only with sleeves or fittings to join pipe ends together, the sleeve or fitting has relatively little, if any, torque urging the sleeve or fitting to rotate about the pipes or tubings. However, especially in the case of valves, the valve actuator, if not oriented perfectly vertically or when the handle is actuated, may result in a tendency for the valve to rotate about the pipes or tubings connected to the valve inlet and the valve outlet. Such rotation of the valve may facilitate leakage or at least gives the appearance of an inadequate connection between the valve and the pipes or tubings. Accordingly, in the preferred embodiments, the teeth ring is fixed relative to the valve (by friction or by a notch or other arrangement) so that the teeth ring does not readily rotate relative to the valve. In this way, the connection between the valve and the pipe or tubing received by the push-fit connection arrangement is improved.

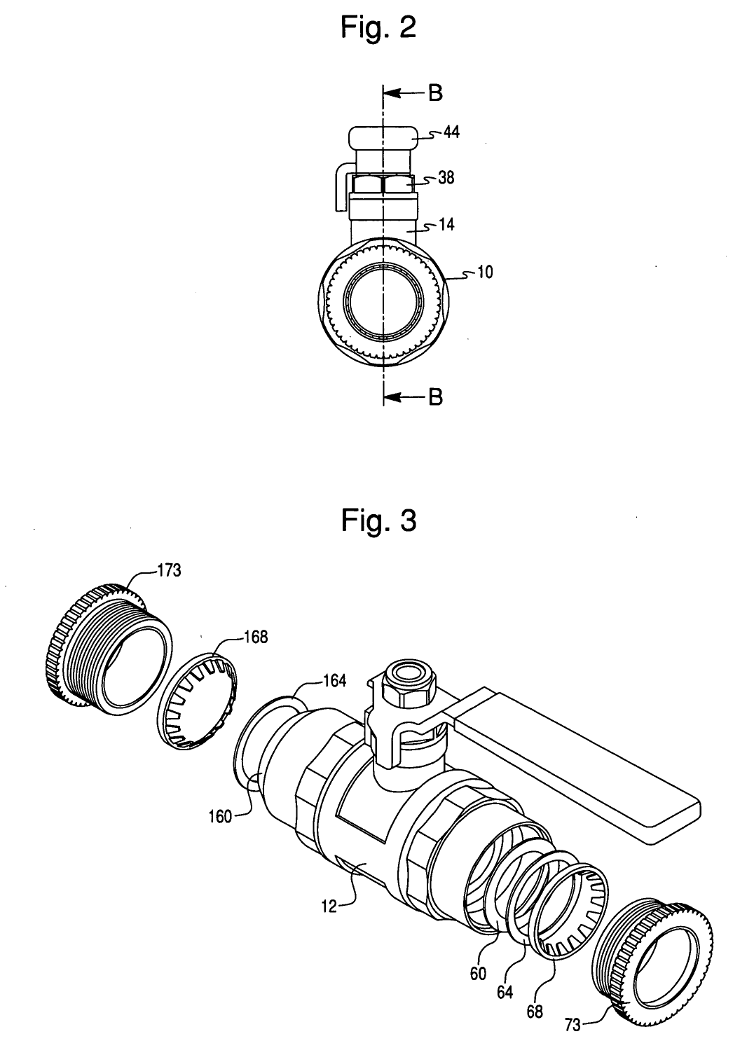

With reference now to FIG. 2, the passageway through the valve 10 is shown with the ball valve member in the open position. Preferably, the passageway through the ball valve member corresponds to the inner diameter of the pipe or tubing to be connected to the inlet and outlet of the valve.

With reference now to FIG. 3, the sequence of components comprising the push-fit connections are shown. The outermost members are the teeth ring retainers 73, 173, then the teeth rings 68, 168, then the annular rings 64, 164, then the O-rings 60, 160, and finally the ball valve housing 12.

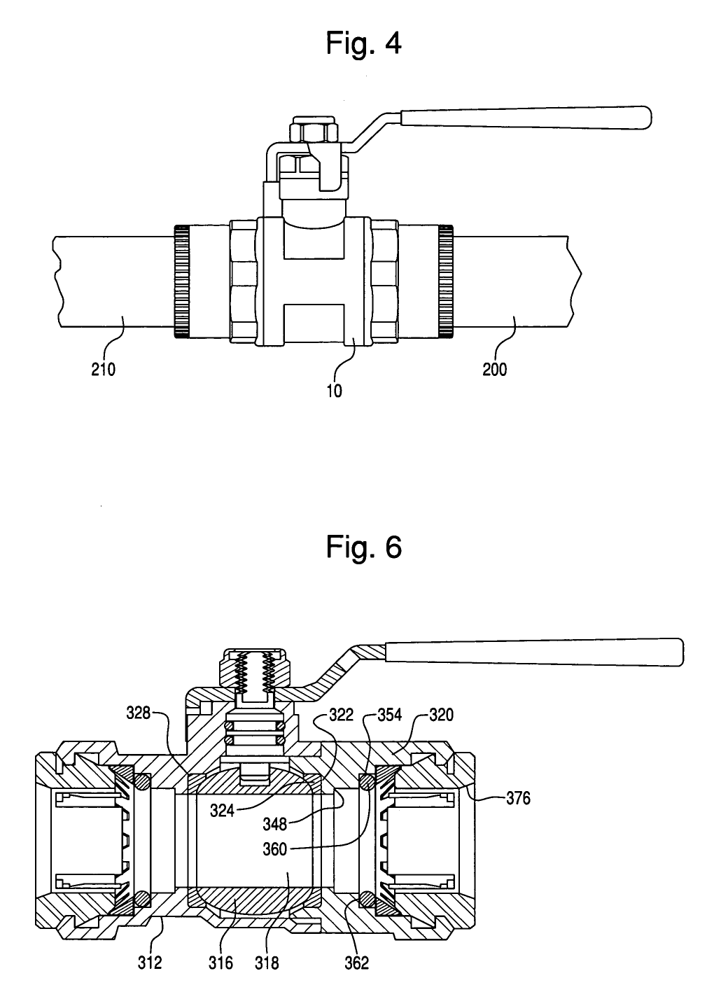

With reference to FIG. 4, a valve according to the present invention is shown with piping 200, 210 provided in a push-fit connection in an inlet and an outlet of the valve. The valve may be provided in various sizes, as desired, including, for example, ½ inch, ¾ inch, and 1 inch. Other sizes, including metric sizes, may be provided as appropriate.

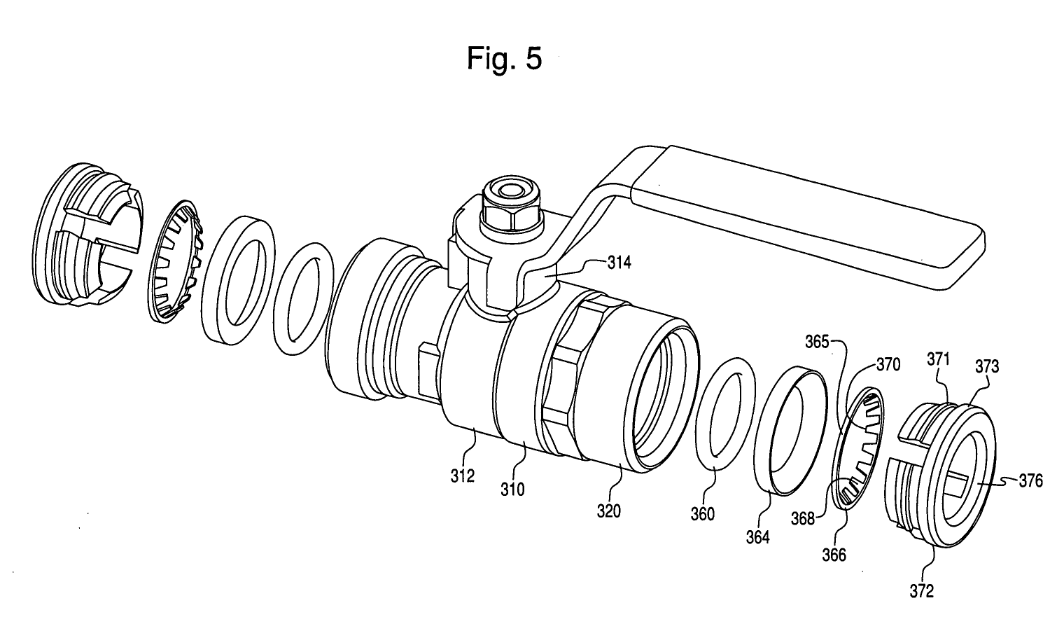

With reference now to FIG. 5, another valve 310 comprises a central housing member 312, which is generally cylindrical in shape, having a radially extending portion 314. A ball valve member 316 (see also, FIG. 6) is provided within the interior of the central housing member 312 and the ball valve member 316 has a passageway 318 which extends through the ball valve member 316. A first ball valve retaining member 320 is threaded into one end of the central housing member. The first ball valve member 320 has a shoulder 322 which carries an annular seal or valve seat 324. The annular seal or valve seat 324 receives an outer surface of the ball valve member 316.

In the valve 310, the central housing member 312 has a shoulder 328 which carries an annular seal or valve seat 330. The annular seal or valve seat 330 receives an outer surface of the ball valve member.

In the embodiment of FIGS. 5 and 6, the arrangement for actuating movement of the ball valve member 316 is substantially identical to that of the embodiment of FIG. 1.

As in the embodiment of FIG. 1, the first ball valve retainer 320 has a pipe shoulder 348 which has a diameter along an axial surface which corresponds to and is slightly larger than the outside diameter of the pipe or tubing to be connected to the valve at the first ball valve retainer 320. The shoulder 348 also has an annular, radial surface which limits the axial movement of the pipe or tubing when being urged toward the ball valve member 316.

With continued reference to FIG. 6, moving away from the ball valve member, immediately after the pipe shoulder 348, the first ball valve retainer 320 has an O-ring shoulder 354. The O-ring shoulder 354 has a diameter along an axial surface which is slightly less than the cross-sectional diameter of an O-ring 360 so that the O-ring will be compressed when the pipe or fitting is received within the first ball valve retainer 320. The O-ring shoulder 354 also has an annular, radial surface which has a width which is slightly less than the diameter of the O-ring 360 again so that the O-ring 360 is compressed when the ball valve retainer 320 receives the pipe or fitting. In the preferred embodiment, the sealing member is an O-ring but other suitable sealing members could be used in place of the O-ring 60. For example, an annular lip seal, or gasket, not shown, could be provided on the O-ring shoulder 54 to seal the pipe relative to the ball valve retaining member 20.

With reference also to FIG. 5, continuing to move away from the ball valve member 316, the ball valve retainer 320 next has an annular ring shoulder 362 which has a diameter that is slightly larger than the O-ring shoulder diameter. An annular ring 364 is positioned on the shoulder with the annular ring 364 having an outside diameter which is slightly less than the outside diameter of the annular ring shoulder 362. The annular ring 364 is generally triangular in cross section, having a generally flat surface that contacts the O-ring (similarly to the annular member 64 in the embodiment of FIG. 1).

A teeth ring 366 is positioned on the annular ring 364 with a plurality of individual teeth 368 pointed generally inwardly toward the ball valve member 316. The teeth 368 have a generally flat end 370 so as to securely grip the outer surface of the pipe or fitting received within the first ball valve retainer without piercing or damaging the outer pipe surface. The teeth ring is preferably formed of spring steel but other materials may be used for the teeth ring depending upon the composition of the pipe or other fitting to be received by the teeth ring.

The teeth ring 366 has an outer ring portion 365 which connects the teeth 368 to one another. The outer ring portion 365 abuts the annular ring 364 so that movement of the teeth ring 366 toward the ball valve member is stopped by the annular ring 364. The teeth ring is bent radially inwardly and toward the ball valve member 316 and is cut away in a series of generally V shaped segments so as to form the individual teeth 368. The triangular shape of the annular ring 364 both positions the outer ring portion 365 and also limits the movement of the individual teeth 368 upon insertion of a pipe end.

A teeth ring retainer 373 is received by the first ball valve retainer 320 so as to maintain the teeth ring 366 in position on the annular ring 364 and to maintain the annular ring 364 in position on the annular ring shoulder. The teeth ring retainer 373 is snap-fit into the first ball valve retainer and has a series of slots extending axially along a portion of the teeth ring retainer to facilitate insertion of the teeth ring retainer into the first ball valve retainer. The teeth ring retainer has an end which urges the outer ring portion of the teeth ring against the annular member 364 and an annular projection which extends toward the ball member beyond the outer ring portion (when assembled) so as to limit movement of the individual teeth away from the ball member. In this way, the portion of the teeth ring retainer that is adjacent the teeth ring 366 has a corresponding cross section so as to direct the teeth radially inwardly and generally toward the ball valve member. The axially innermost portion of the teeth ring retainer also prevents the teeth from bending away from the ball valve member, i.e., if the pipe or fitting is being pulled out of the ball valve retainer 320.

The teeth ring retainer 373 has an annular shoulder 371 which is received by a corresponding ridge or shoulder of the first ball retaining member 320 to prevent removal of the teeth ring retainer after assembly. The teeth ring retainer 373 has an inner diameter which is slightly larger than the outside diameter of the pipe or fitting to be received by the first ball member retainer 320. The teeth ring retainer 373 also has a shoulder 372 which abuts the outermost portion of the first ball retainer 320 and thereby limits the position of the teeth ring retainer 373 relative to the teeth ring 366. In this way, the teeth ring retainer is properly positioned relative to the teeth ring during assembly of the valve.

Because the teeth ring retainer 372 cannot be readily removed from the ball valve retainer (as by unscrewing, etc.) a sealant is generally not used on the teeth ring retainer.

The end of the teeth ring retainer which is positioned axially away from the ball valve member 316 preferably has a tapered end 376 so as to facilitate insertion of the pipe end or fitting into the teeth ring retainer. In this way, the tapered end 376 acts as a guide to direct the pipe end or fitting into the teeth ring retainer.

In the embodiment of FIGS. 5 and 6, the ball valve central housing member 312 has a push-fit connection arrangement which is identical to the push-fit connection arrangement provided for the ball valve retainer and need not be repeated.

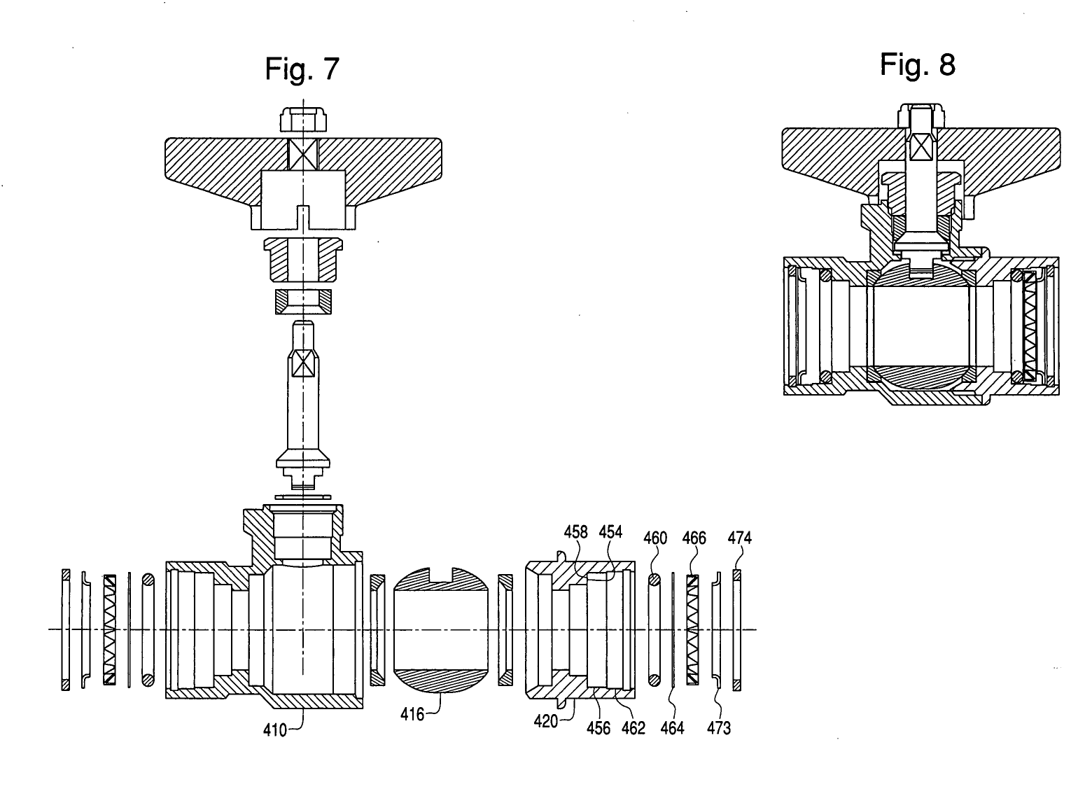

With reference to FIGS. 7 and 8, another valve 410 corresponds generally to the valves 10 and 310 of the embodiments of FIGS. 1 through 6. In the embodiment of FIGS. 7 and 8, however, the actuator for moving the ball member is configured differently, primarily because the valve 410 is preferably formed of plastic rather than metal. However, different arrangements for actuating the ball valve member may be used, as desired, in any of the disclosed embodiments.

With reference to the push fit connection arrangement of the valve of FIGS. 7 and 8, a first ball valve retainer 420 for a ball valve member 416 has an O-ring shoulder 454. The O-ring shoulder 454 has a diameter along an axial surface 456 which is slightly less than the cross-sectional diameter of an O-ring 460 so that the O-ring will be compressed when the pipe or fitting is received within the first ball valve retainer 420. The O-ring shoulder 454 also has an annular, radial surface 458 which has a width which is slightly less than the diameter of the O-ring 460 again so that the O-ring 460 is compressed when the ball valve retainer 420 receives the pipe or fitting.

Continuing to move away from the ball valve member 416, the ball valve retainer 420 next has an annular ring shoulder 462 which has a diameter that is slightly larger than the O-ring shoulder diameter. An annular ring 464 is positioned on the shoulder with the annular ring 464 having an outside diameter which is slightly less than the outside diameter of the annular ring shoulder 462.

A teeth ring 466 is positioned on the annular ring 464 with a plurality of individual teeth pointed generally inwardly toward the ball valve member 416. The teeth ring 466 corresponds generally to the teeth ring 66 of the embodiment of FIG. 1.

A teeth ring retainer 473 comprises an annular member which is “L” shaped in cross section to maintain the teeth ring 466 in position on the annular ring 464 and to maintain the annular ring 464 in position on the annular ring shoulder.

The teeth ring retainer 473 has an inner diameter which is slightly larger than the outside diameter of the pipe or fitting to be received by the first ball member retainer 420. The teeth ring retainer 473 has a radial ring portion which abuts the teeth ring. An axial portion of the teeth ring retainer 473 extends toward the ball member 416 and directs the teeth radially inwardly and generally toward the ball valve member. The axially extending innermost portion of the teeth ring retainer also prevents the teeth from bending away from the ball valve member, i.e., if the pipe or fitting is being pulled out of the ball valve retainer 420.

The teeth ring retainer 473 is retained in position by a ring 474 which has a slightly larger outside diameter than the innermost diameter of a shoulder of the ball valve member retainer. For example, the ring 474 may have a radial slit and be slightly compressed during assembly so as to be positioned beneath the shoulder of the ball valve member retainer. The ring is then released so as to increase its outside diameter and thereby maintain its position beneath the shoulder.

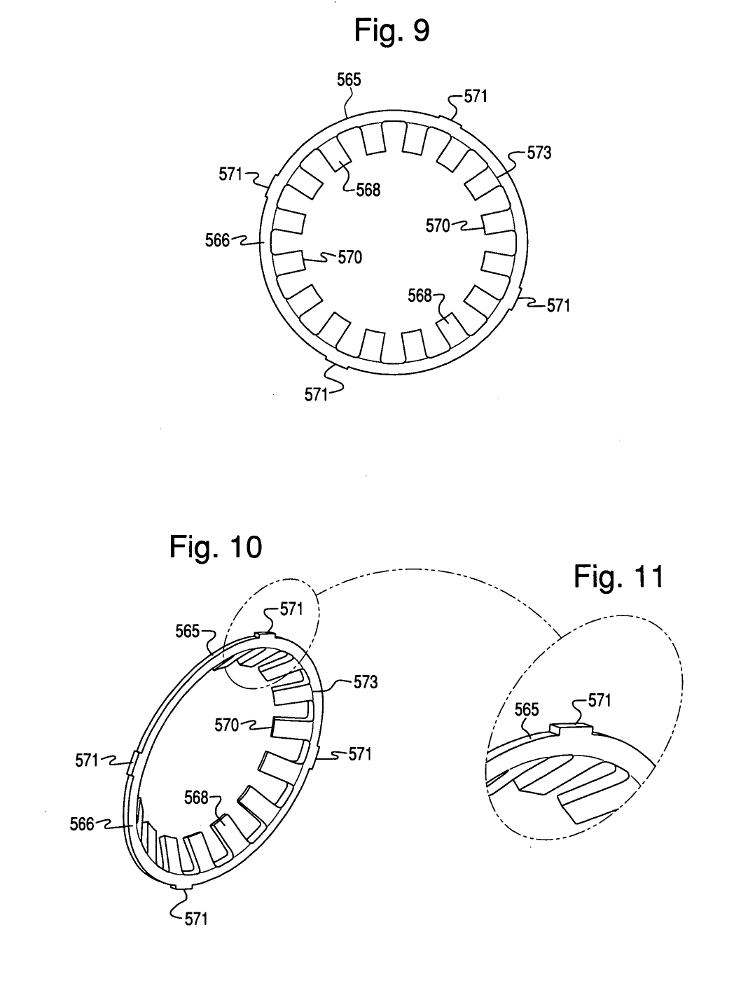

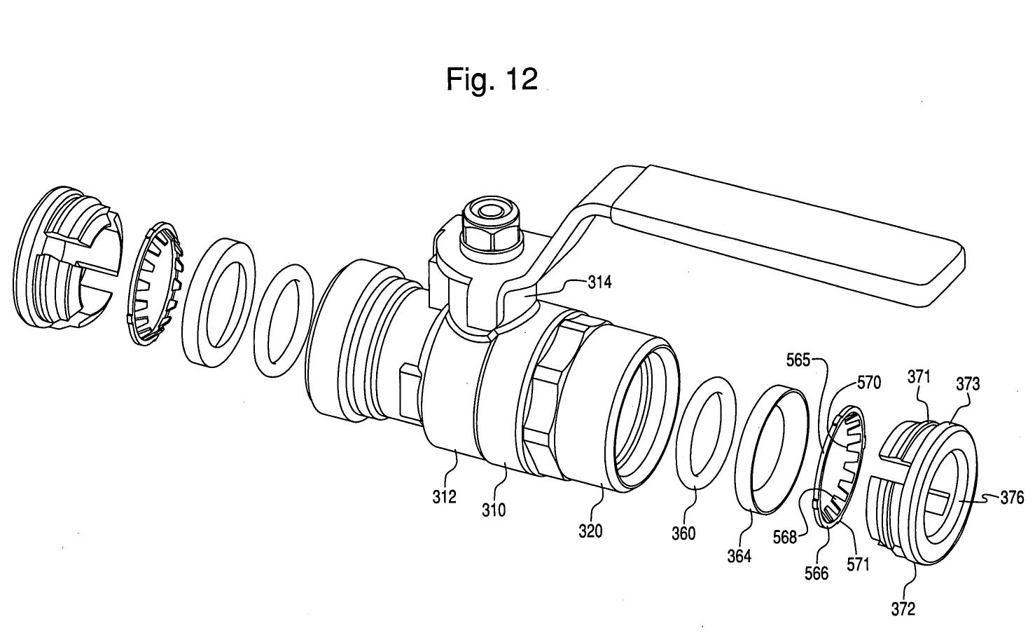

With reference now to FIG. 9, a teeth ring 566 includes an annular ring 565 and a plurality of teeth 568 directed radially inwardly of the ring 565. The annualr ring 565 has a plurality of tabs 571 provided about the outer perimeter of the annular ring 565. In the preferred embodiment of the teeth ring 566, there are four tabs 571 spaced apart by 90°. Each of the tabs projects only slightly beyond the outer circumference of the annular ring 565 as shown in more detail in FIG. 11.

The teeth ring 566 of FIGS. 9-11 is the preferred embodiment of the teeth ring and may be used in each of the various valves illustrated and described herein. In the preferred embodiment of the teeth ring, the individual teeth have generally parallel sides rather than the tapered sides as shown in earlier figures. However, whether the sides are tapered or parallel is generally a matter of design choice and a result of the manufacturing process. It is generally understood that making a teeth ring in which the individual teeth have parallel sides is easier and perhaps less expensive that making teeth with tapered sides. In addition, there is some indication that teeth with parallel sides may have better grip performance when the teeth ring is under tension due to a relatively stronger surface where the tension stress is distributed over the teeth ring.

In the preferred embodiment, the teeth ring 566 is produced by stamping a metal sheet but other methods of production that result is a suitable teeth ring are within the scope of the present invention. The annular ring of the teeth ring provides a correct or desired alignment of the gripping teeth initially about the pipe. The annular ring also permits the provision of the tabs 571 about the perimeter of the teeth ring.

During assembly of a valve with the teeth ring 566, the four flat tabs provided about the outer perimeter of the teeth ring are pushed against the valve sidewall. The flat tabs are configured to engage the valve sidewall so as to eliminate or significantly reduce the possibility of valve rotation relative to the pipe end being gripped by the teeth ring. The flat tabs are preferably pushed into the sidewall of the valve during assembly of the teeth ring in the valve housing and the tabs preferably engage the sidewall of the valve before the pipe end is inserted.

With reference to FIG. 12, the assembly of a valve using the teeth ring of FIGS. 9-11 is shown in which similar or identical parts from earlier figures bear the same reference numerals. The assembly of the components is substantially as described above in connection with the valve of FIG. 5.

The principles, preferred embodiments and mode of operation of the present invention have been described in the foregoing specification. However, the invention which is intended to be protected is not to be construed as limited to the particular embodiments disclosed. The embodiments are therefore to be regarded as illustrative rather than as restrictive. Variations and changes may be made without departing from the spirit of the present invention. Accordingly, it is expressly intended that all such equivalents, variations and changes which fall within the spirit and scope of the present invention as defined in the claims be embraced thereby.

What is claimed is:

1. A valve having an integrally formed push-fit connection arrangement, comprising:
a valve housing comprising an inlet and an outlet;
a valve member provided within the valve housing, the valve member being selectively positioned to control communication between said inlet and said outlet;
said valve housing further comprising an integrally formed push-fit connection arrangement comprising a teeth ring having a plurality of teeth directed generally radially inwardly and generally toward the interior of said valve housing, said teeth ring being provided within at least one of said inlet and said outlet of said valve housing.

2. The valve of claim 1, further comprising an annular sealing member provided axially between said teeth ring and said valve housing.

3. The valve of claim 2 wherein said valve housing further comprises a first shoulder which limits movement of the teeth ring toward the valve member.

4. The valve of claim 3 further comprising an annular ring, said annular ring being provided between the teeth ring and the first shoulder.

5. The valve of claim 4 wherein said teeth ring and said annular ring are separately formed, said annular ring extending generally radially, said teeth ring having an annular portion which extends generally axially, said annular portion of said teeth ring being oriented generally perpendicular with respect to said annular ring.

6. The valve of claim 4 wherein said teeth ring and said annular ring are separately formed, said annular ring being generally triangular in cross section, said teeth ring having an annular portion which abuts the annular ring, said teeth ring further comprising a plurality of tabs which extend radially outwardly to engage a sidewall of said valve housing.

7. The valve of claim 4, wherein said valve housing further comprises a second shoulder provided between the first shoulder and the valve member, said second shoulder having a smaller diameter than said first shoulder.

8. The valve of claim 7 wherein said annular sealing member is provided between said second shoulder and said annular ring.

9. The valve of claim 4, wherein said valve housing further comprises a third shoulder, said third shoulder being provided between said second shoulder and said valve member, said third shoulder having a smaller diameter than said second shoulder.

10. The valve of claim 9 wherein said third shoulder has a diameter corresponding to the outside diameter of a pipe to be received within the teeth ring.

11. The valve of claim 10, wherein said sealing member, when not compressed, has an inside diameter which is smaller than the outside diameter of said pipe to be received within the teeth ring.

12. The valve of claim 11 wherein said sealing member is an O-ring, said second shoulder and said annular ring forming a groove for said O-ring.

13. The valve of claim 3 further comprising a teeth ring retainer which maintains the teeth ring positioned between the first shoulder and the teeth ring retainer and wherein rotation of the teeth ring relative to the valve housing is prevented.

14. The valve of claim 13 wherein the teeth ring retainer is permanently fixed to the valve housing after assembly of the valve and wherein said teeth ring further comprises a plurality of tabs which extend radially outwardly to engage a sidewall of said valve housing to prevent said rotation of the teeth ring relative to the valve housing.

15. The valve of claim 3 wherein the valve member is a ball.

16. The valve of claim 1 wherein each of said inlet and said outlet of said valve housing comprises:
a teeth ring having a plurality of teeth directed generally radially inwardly and generally toward the interior of said valve housing;
an annular sealing member provided between said teeth ring and said valve member;
a first shoulder which limits movement of the teeth ring toward the valve member;
an annular ring, said annular ring being provided between the teeth ring and the first shoulder;
a second shoulder provided between the first shoulder and the valve member, said second shoulder having a smaller diameter than said first shoulder, said annular sealing member being provided between said second shoulder and said annular ring;
a third shoulder, said third shoulder being provided between said second shoulder and said valve member, said third shoulder having a smaller diameter than said second shoulder, said third shoulder having a diameter corresponding to the outside diameter of a pipe to be received within the teeth ring, said sealing member, when not compressed, having an inside diameter which is smaller than the outside diameter of the pipe to be received within the teeth ring;
a teeth ring retainer which maintains the teeth ring positioned between the first shoulder and the teeth ring retainer.

17. The valve of claim 16 wherein each of said teeth ring retainers is permanently fixed to the valve housing after said valve is assembled and wherein a force required to rotate the teeth ring relative to the valve housing after assembly of the push-fit connection arrangement is greater than a torque provided by the valve actuator tending to rotate the valve housing about the inlet and outlet.

18. The valve of claim 16 wherein the valve member is a ball.

19. The valve of claim 16 wherein each of said teeth retainers prevents teeth of the associated teeth ring from moving away from the valve member, and wherein said annular ring extends generally radially, said teeth ring having an annular portion which extends generally axially, said annular portion of said teeth ring being oriented generally perpendicular with respect to said annular ring.

20. The valve of claim 13 wherein said teeth ring retainer has an inner annular protrusion which prevents teeth of said teeth ring from moving away from the valve member.

21. The valve of claim 1 wherein said valve housing comprises a central valve housing member and at least one valve member retainer.

22. The valve of claim 1 wherein said inlet and said outlet each comprises:
a teeth ring having a plurality of teeth directed generally radially inwardly and generally toward the interior of said valve housing;
an annular sealing member provided axially between said teeth ring and said valve member housing;
a first shoulder which limits movement of the teeth ring toward the valve member;
an annular ring, said annular ring being provided between the teeth ring and the first shoulder, said annular ring extending generally radially, said teeth ring having an annular portion which extends generally axially, said annular portion of said teeth ring being oriented generally perpendicular with respect to said annular ring;
a second shoulder provided between the first shoulder and the valve member, said second shoulder having a smaller diameter than said first shoulder, said annular sealing member being provided between said second shoulder and said annular ring;
a third shoulder, said third shoulder being provided between said second shoulder and said valve member, said third shoulder having a smaller diameter than said second shoulder, said third shoulder having a diameter corresponding to the outside diameter of a pipe to be received within the teeth ring, said sealing member when not compressed having an inside diameter which is smaller than the outside diameter of the pipe to be received within the teeth ring; and,
a teeth ring retainer which maintains the teeth ring positioned between the first shoulder and the teeth ring retainer.

23. The valve of claim 22 wherein each of said teeth ring retainers is permanently fixed to the respective valve member retainer.

24. The valve of claim 23 wherein the valve member is a ball.

25. The valve of claim 22 wherein said teeth ring retainer prevents teeth of the teeth ring from moving away from the valve member.

26. The valve of claim 22 wherein said teeth ring retainer has an inner annular protrusion which prevents teeth of said teeth ring from moving away from the valve member.

27. The valve of claim 22 wherein said annular ring and said teeth ring are separately formed.

28. The valve of claim 26 wherein said teeth ring retainer is threaded onto said valve housing.

29. The valve of claim 26 wherein said teeth ring retainer is snap-fit into said valve housing.

30. The valve of claim 29 wherein said teeth ring retainer has a plurality of axially oriented slots and an annular outer shoulder which is adapted to be received by said valve housing to facilitate said snap-fit of said teeth ring retainer into said valve housing.
